(19) United States
(12) Patent Application Publication
(10) Pub. No.: US 2006/0049388 A1
(43) Pub. Date: Mar. 9, 2006

(54) Wire mesh sandwich construction and method for making the same

(76) Inventors: James M. Knott JR., Whitinsville, MA (US); James M. Knott SR., Whitinsville, MA (US)

Correspondence Address: GAUTHIER & CONNORS, LLP, 225 FRANKLIN STREET, BOSTON, MA, 02110, US

(21) Appl. No.: 10/929,921

(22) Filed: Aug. 30, 2004

(51) Int. Cl. B66D 3/08

(52) U.S. Cl. 254/400

(57) ABSTRACT

A wire mesh sandwich construction which comprises an array of line wires, an array of cross wires overlying said array of line wires and a barrier material disposed between the array of line wires and the array of cross wires. The array of line wires is spaced apart from the array of cross wires to form points of intersection therebetween. The array of line wires is joined to said array of cross wires at the points of intersection and through the barrier material, thus securing the barrier material between the array of line wires and the array of cross wires.

### BACKGROUND OF THE INVENTION

1. Field of the Invention

This invention relates generally to wire mesh sandwich constructions and in particular to wire mesh sandwich constructions that can be used for general fencing applications, e.g., fencing that is used to control erosion at construction sites.

2. Description of the Prior Art

Residential, commercial, and industrial constructions sites produce voluminous piles of loose and compacted piles of soil that are susceptible to erosion by wind and rainfall. One way in which to staunch such erosion from contaminating environmentally sensitive areas situated adjacent to industrial and commercial construction sites includes the erection of a silt fence.

Silt fences currently in use typically comprise a wire fabric that includes a welded or woven wire mesh having a front surface and a back surface and a ply of barrier material. The barrier material is usually a woven or non-woven plastic geotextile. It is secured to the wire mesh by clips or ties to the front surface or optionally the back surface of the wire mesh. The wire fabric can be supported in a substantially perpendicular manner from the ground by stakes, which are positioned along a boundary to separate an environmentally sensitive area from a construction site. The barrier material obstructs the travel of the eroding piles of earth produced at the construction site to the environmentally sensitive areas.

The practice of erecting the silt fences entails attaching the barrier material to the front or optionally the back surface of the wire mesh. The wire mesh supports the barrier material attached thereto. The mesh with the barrier material attached can then be raised in a substantially perpendicular manner from the ground with the stakes. Attaching barrier materials to the front or optionally the back surface of the wire mesh is time consuming and increases the costs that are associated with the assembly and erection of the silt fence. Moreover, while the slit fence is in service, tears in the attached barrier material tend to develop at stress points where the material is clipped or tied to the wire mesh. These tears in the barrier material require continued maintenance.

A need exists, therefore, for an improved product that can be used for erosion control, e.g., when used to construct a silt fence, that addresses the aforementioned problems.

### SUMMARY OF THE INVENTION

In one aspect, the invention comprises a wire mesh sandwich construction which includes an array of line wires, an array of cross wires overlying said array of line wires and a barrier material disposed between the array of line wires and the array of cross wires. The array of line wires is spaced apart from the array of cross wires to form a grid pattern with points of intersection therebetween. The array of line wires is joined to the array of cross wires at the points of intersection and through the barrier material, thus securing the barrier material between the array of line wires and the array of cross wires.

In another aspect, the invention comprises a method for making a wire mesh sandwich construction which includes the steps of providing an array of line wires, overlaying a barrier material onto the array of lines wires to form a layered construction, placing an array of cross wires on top of the barrier material to form a mesh construction having points of intersection between said array of line wires and said array of cross wires, and welding the array of line wires to the cross wires through the barrier material at the points of intersection to form the wire mesh sandwich construction.

In yet another aspect, the invention comprises a method for making a wire mesh sandwich construction which includes the steps of providing an array of line wires, overlaying a barrier material having perforations therein onto the array of line wires to form a layered construction, placing an array of cross wires onto the barrier material to form a mesh construction having points of intersection between the array of line wires and the array of cross wires that are in registration with the perforations and welding that array of line wires to the array of cross wires through said perforations at the points of intersection to form the wire mesh sandwich construction.

These and other objects, features and advantages of the present invention will become more apparent in light of the following detailed description of the preferred embodiments thereof, as illustrated in the accompanying drawings.

### BRIEF DESCRIPTION OF THE DRAWINGS

FIG. 1 is a partial perspective view of a wire mesh sandwich construction with portions of the wire mesh sandwich construction broken away;

FIG. 2 is a partial side view of the silt fence with a portion of the fence broken away;

FIG. 3 is a sectional view of FIG. 2 taken along lines 1-1;

FIG. 4 is a sectional view of FIG. 2 taken along lines 2-2;

FIG. 5 is a sectional view of FIG. 2 taken along lines 3-3; and

FIG. 6 is a schematic illustration of a system for manufacturing a silt fence.

### DETAILED DESCRIPTION OF THE INVENTION

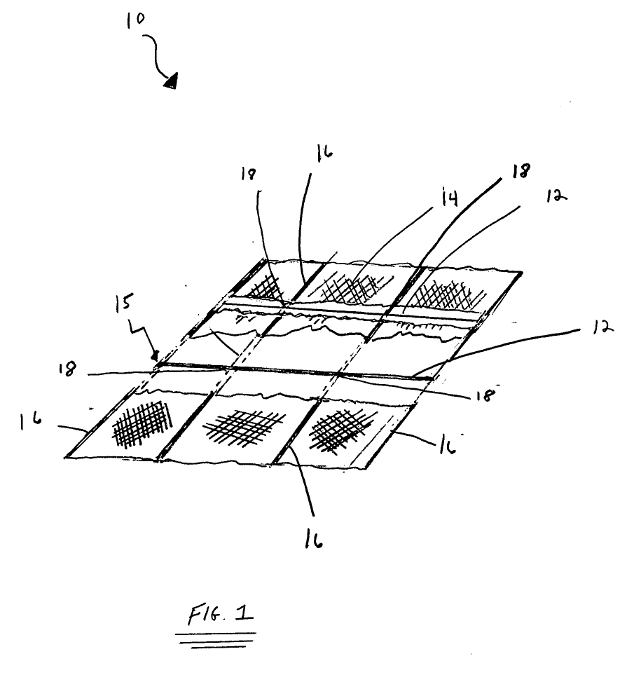

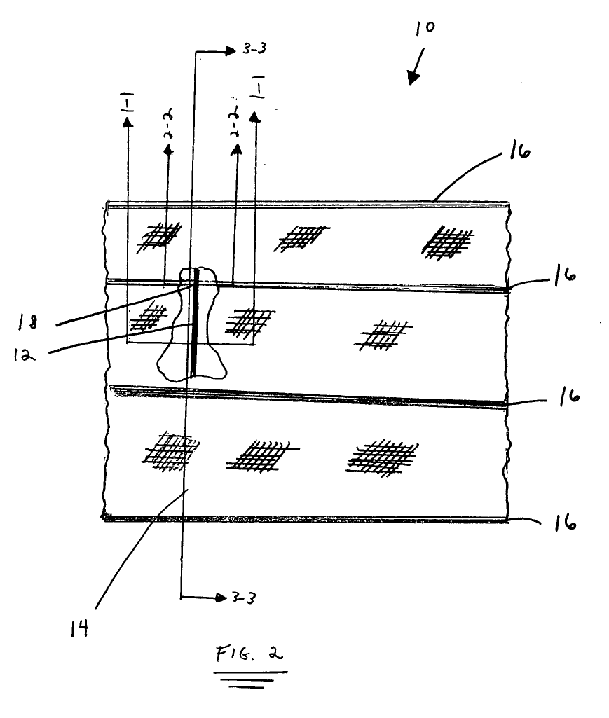

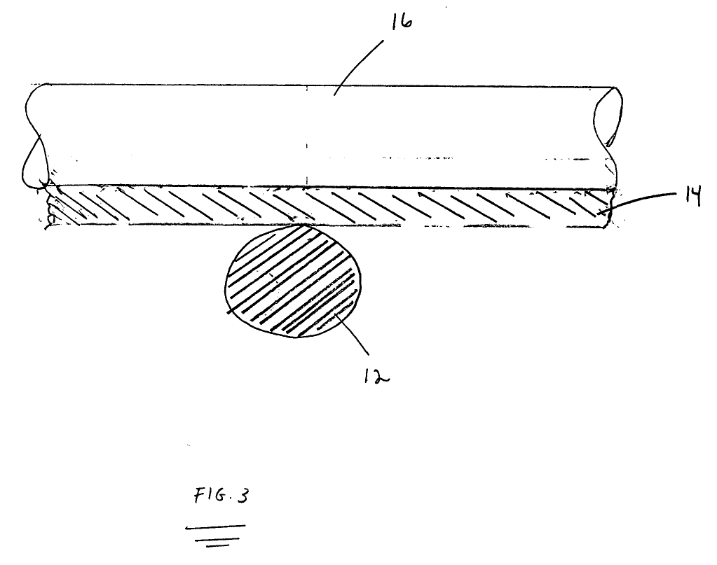

With reference initially to FIGS. 1 and 2, a wire mesh sandwich construction is generally depicted at 10. The wire mesh sandwich construction 10 is comprised of an array of line wires 12 positioned over an array of cross wires 16 to form a mesh construction 15. A barrier material 14 is positioned between the array of line wires 12 and the array of cross wires 16. The array of line wires 12 and the array of cross wires 16 can be comprised of wires drawn from ferrous or non-ferrous rod. The wires can then be surface coated for protection or aesthetic purposes. The barrier material 14 can be comprised of plastics, wovens, non-wovens, natural weaves, e.g., canvases, papers, and admixtures of natural and synthetic fibers. Commercial examples of the barrier material 14 can include DuPont Tyvex, Beltech woven polypropylene geosynthetic geotextile, Amcon woven geotextiles or woven coated polypropylene geosynthetics, Airspace Saver (Fabrene) high density woven polyethylene coated fabric with polyester straps, Exxon geotextile (3601), Fabrene high tensile strength lightweight woven polyethylene, GeoCover geotextile (601) and GSE high-density polyethylene geomembrane. As shown in the broken away portions of FIGS. 2 and 3, the line wires 12 and cross wires 16 are welded, e.g. resistance welded or pressure welded, together at cross over locations 18.

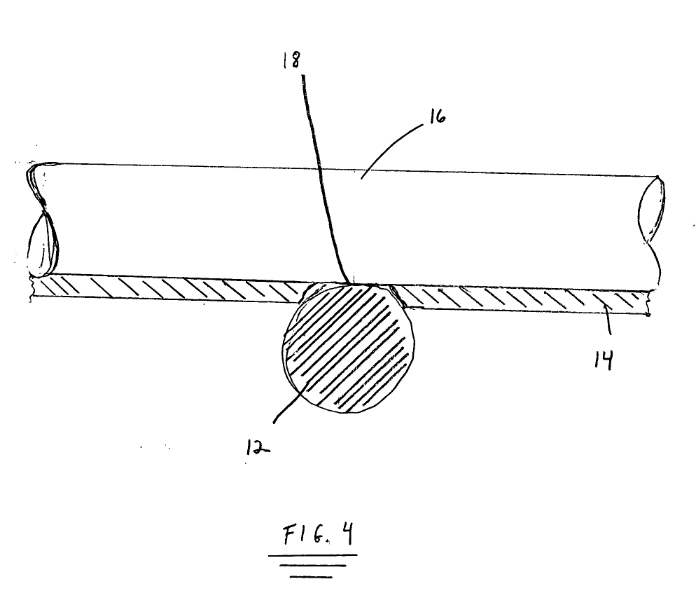

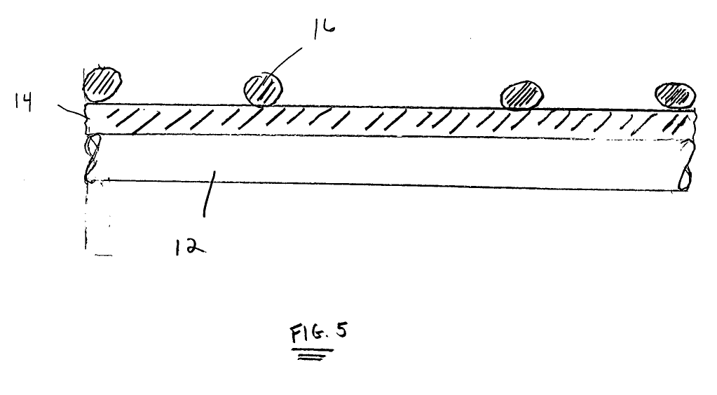

Referring to FIG. 3, a sectional view of FIG. 2 is shown taken along lines 1-1. The material 14 is positioned between the cross wire 16 and the line wire 12. Referring to FIG. 4, a sectional view of FIG. 2 is shown taken along lines 2-2. The line wire 12 is welded to the cross wire 16 through the barrier material 14 at the cross over location 18. In an alternative embodiment, the line wire 12 is welded to the cross wire 16 through a perforation in the material 14 at the cross over location 18. Referring to FIG. 5, a sectional view of FIG. 2 is shown taken along lines 3-3. The barrier material 14 is positioned between the line 12 and the cross wires 16.

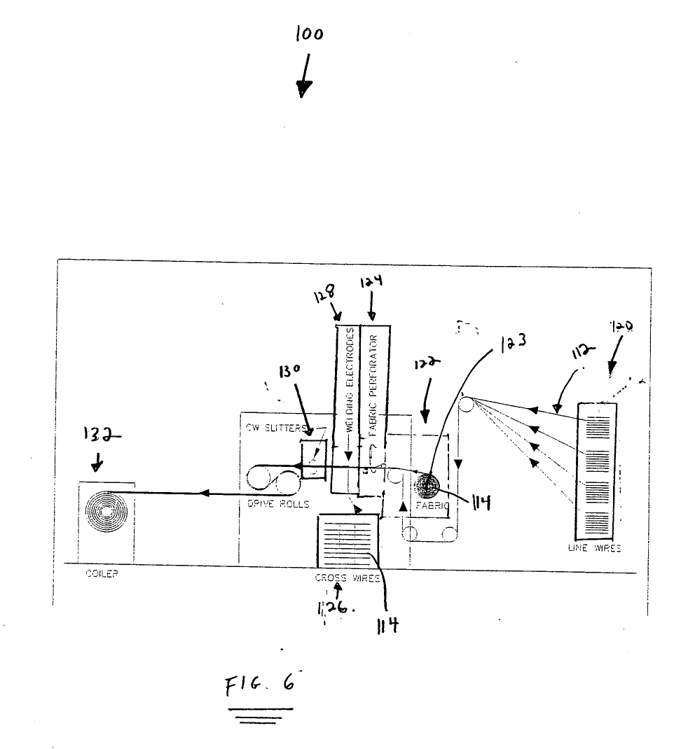

With reference to FIG. 6, a schematic illustrating a system for manufacturing the wire mesh sandwich construction 10 is shown. The system 100 includes a first station 120, a second station 122, a third station 124, a fourth station 126, a fifth station 128, a sixth station 130 and a seventh station 132.

A longitudinally spaced array of line wires 112 is drawn from the first station 120 and conveyed to a second station 122, which comprises a roll 123 of barrier material 114, e.g., a woven geotextile fabric that conforms to the requirements of Specification No. DMS-6230 (2003) of the Texas Department of Transportation. The wires in the array of line wires 112 are spaced apart one from the other at a distance of 4 inches, are made of galvanized steel and have nominal diameters of 0.099 or optionally 0.080 inches. The barrier material 114 is drawn from the roll 123 and overlaid on the array of line wires 112 to form a layered construction (not shown). The layered construction is conveyed to the fifth station 128 whereupon a longitudinally spaced array of cross wires 116 is drawn from a fourth station 126 over the barrier material 114 of the layered construction. The array of cross wires 116 is transverse to the array of line wires 112 and forms a grid pattern (not shown) having points of intersection between the array of cross wires 116 and the array of line wires 112. The wires in the array of cross wires 116 are spaced one from the other at a distance of 2 inches, are made of galvanized steel and have nominal diameters of 0.099 inches or optionally 0.080 inches. The layered construction is conveyed to a fifth station 128 wherein the array of cross wires 116 are resistance welded to the array of lines wires through the barrier material 114 and at the points of intersection by direct current thereby forming the wire mesh sandwich construction. Subsequently, the wire mesh sandwich construction is indexed forward to and coiled at a seventh station 132.

In an alternative embodiment, the layered construction is conveyed to a third station 124, which comprises a fabric perforator prior to be drawn to the fifth station 128. The barrier material 114 of the layered construction is perforated by heating, e.g., the application of hot tips, such that the resulting perforations will register with the points of intersection. At the fifth station 128, the array of cross wires 116 is resistance welded to the array of line wires 112 through the perforations of the barrier material 114 and at the points of intersection by alternating current to form the wire mesh sandwich construction.

In operation, the overlaying of the barrier material 114 onto the array of line wires 112 to form the layered construction, the drawing of the array of cross wires 116 over the barrier material 114 of the layered construction, the optional perforating of the barrier material 114 and the resistance welding of the array of cross wires 116 to the array of line wires 112 through the barrier material 114, or optionally through the perforations, at the points of intersection to form the wire mesh sandwich construction can occur in rapid or slow succession. Once the wire mesh sandwich construction is formed, the same is then indexed forward to the seventh station thereby drawing the barrier material 114 from the roll 123.

In another embodiment, the wire mesh sandwich construction can be indexed to a sixth station 130 prior to being indexed to the seventh station 132. The sixth station 130, which comprises slitters, is used to shear any wires of the array of cross wires 116 that extend beyond the array of line wires 112.

In addition, to silt fences, it is contemplated that the wire mesh sandwich construction can also be used for any purposes where a barrier is needed, e.g., gabion baskets and mattresses for retaining earth, bastions, cages for entrapping aquatic fauna, security fencing, privacy screens, snow-fencing and any other general fencing applications.

Although the present invention has been shown and described with a preferred embodiment thereof, various changes, omissions and additions to the form and detail thereof, may be made therein, without departing from the spirit and scope of the invention.

What is claimed is:

1. A method for making a wire mesh sandwich construction which comprises:
providing an array of line wires;
overlaying a barrier material onto said array of lines wires;
placing an array of cross wires onto said barrier material, said array of cross wires spaced apart from said array of line wires to form a mesh construction, said mesh construction having points of intersection between said array of line wires and said array of cross wires; and
securing said array of line wires to said array of cross wires through said barrier material at said points of intersection to form the wire mesh sandwich construction.

2. The method of claim 1 wherein said array of line and said array of cross wires are comprised of metal.

3. The method of claim 1 wherein said barrier material comprises a geotextile.

4. The method of claim 1 wherein securing comprises applying a direct current through said array of cross wires to weld said array of line wires to said array of cross wires.

5. The method of claim 1 wherein welding comprises welding said line wires to said array of cross wires through said barrier material at said points of intersection thereby securing said array of line wires to said array of cross wires and which further comprises coiling said wire mesh sandwich construction.

6. The method of claim 1 wherein said array of line wires is substantially perpendicular to said array of cross wires.

7. A method for making a wire mesh sandwich construction which comprises:
providing an array of line wires;
overlaying a barrier material having perforations therein onto said array of line wires;
placing an array of cross wires onto said barrier material, said array of cross wires spaced apart from said array of line wires to form a mesh construction, said mesh having points of intersection between said array of line wires and said array of cross wires, said points of intersection being in registration with said perforations;
securing said array of line wires to said array of cross wires through said perforations at said points of intersection to said array of cross wires to form the wire mesh sandwich construction.

8. The method of claim 7 wherein said line and cross wires comprise metal.

9. The method of claim 7 wherein said material comprises a geotextile.

10. The method of claim 7 wherein welding comprising applying an alternating current through said array of cross wires to weld said array of line wires to said array of cross wires.

11. The method of claim 7 wherein welding comprises welding said array of line wires to said array of cross wires through said perforations at said points of intersection thereby securing said array of line wires to said array of cross wires and which further comprises coiling said wire mesh sandwich construction.

12. The method of claim 7 wherein said material is comprised of natural fibrous material.

13. The method of claim 7 wherein said line wires are substantially perpendicular to said array of cross wires.

14. A wire mesh sandwich construction which comprises:
an array of line wires;
an array of cross wires overlying said array of line wires; and
a barrier material disposed between said array of line wires and said array of cross wires, said array of line wires being spaced apart from said array of cross wires to form a grid pattern and points of intersection therebetween, said array of line wires being joined to said array of cross wires at said points of intersection and through said barrier material, thus securing the barrier material between said array of line wires and said array of cross wires.

15. The wire mesh sandwich construction of claim 14 wherein said array of line wires are substantially perpendicular to said array of cross wires.

16. The wire sandwich construction of claim 15 wherein said array of line wires are welded to said array of cross wires at said points of intersection.

17. A composite barrier comprising:
parallel line wires defining one face of said barrier;
parallel cross wires defining an opposite face of said barrier, said cross wires extending transversally across said line wires at intersections; and
a barrier material interposed between said line wires and said cross wires, said line wires being joined to said cross wires through openings in said barrier material at said intersections.

18. The barrier of claim 17 wherein said parallel line wires and said parallel cross wires are orthogonally arranged and said barrier material is comprised of plastic.

19. The barrier of claim 18 wherein said line wires and said cross wires comprise metal.

20. The barrier of claim 17 wherein said line wires are welded to said cross wires through openings in said barrier material at said intersections.
